(19) United States
(12) Patent Application Publication
(10) Pub. No.: US 2025/0165272 A1
(43) Pub. Date: May 22, 2025

(54) METHOD, APPARATUS, DEVICE AND STORAGE MEDIUM OF INFORMATION INTERACTION

(71) Applicant: Beijing Zitiao Network Technology Co., Ltd., Beijing (CN)

(72) Inventors: Shanshan Du, Beijing (CN); Qiankun Wang, Beijing (CN)

(21) Appl. No.: 18/949,151

(22) Filed: Nov. 15, 2024

(30) Foreign Application Priority Data
Nov. 20, 2023 (CN) 202311550557.8

(51) Int. Cl. G06F 9/451; G06F 3/0481

(52) U.S. Cl. CPC G06F 9/453; G06F 3/0481

(57) ABSTRACT

A method, an apparatus, a device and a storage medium for information interaction are provided. The method includes: receiving configuration information for a first shortcut instruction, the configuration information indicating a reply type of a first digital assistant to the first shortcut instruction; and providing an execution result of executing the first shortcut instruction by the first digital assistant to a first user based on the configuration information, a type of at least part of the execution results being consistent with the reply type indicated by the configuration information. In this way, the execution result of the shortcut instruction can be flexibly improved. This advantageously improves the assistance efficiency of the digital assistant to the user as well as the user experience.

### CROSS-REFERENCE

The present application claims priority to Chinese Patent Application No. 202311550557.8, filed on Nov. 20, 2023 and entitled “METHOD, APPARATUS, DEVICE AND STORAGE MEDIUM OF INFORMATION INTERACTION”, the entirety of which is incorporated herein by reference.

### FIELD

Example embodiments of the present disclosure generally relate to the field of computer, and more particularly, to a method, an apparatus, a device, and a computer-readable storage medium of information interaction.

### BACKGROUND

With the development of information technologies, various terminal devices may provide various services to people in terms of work and life. For example, an application providing a service may be deployed in the terminal device. The terminal device or the application thereof may provide assistant-like functionality to a user, to assist the user in completing a task by using the terminal device or the application. How to make such assistant-like functionality better serve users is a technical problem currently being explored.

### SUMMARY

In a first aspect of the present disclosure, a method of information interaction is provided. The method comprises: receiving configuration information for a first shortcut instruction, the configuration information indicating a reply type of a first digital assistant to the first shortcut instruction; and providing an execution result of executing the first shortcut instruction by the first digital assistant to a first user based on the configuration information, a type of at least part of the execution result being consistent with the reply type indicated by the configuration information.

In a second aspect of the present disclosure, an apparatus for information interaction is provided. The apparatus comprises: a configuration information receiving module configured to receive configuration information for a first shortcut instruction, the configuration information indicating a reply type of a first digital assistant to the first shortcut instruction; and an execution result providing module configured to provide an execution result of executing the first shortcut instruction by the first digital assistant to a first user based on the configuration information, a type of at least part of the execution result being consistent with the reply type indicated by the configuration information.

In a third aspect of the present disclosure, a computing device is provided. The computer device comprises: at least one processing unit; and at least one memory coupled to the at least one processing unit and storing instructions executable by the at least one processing unit. The instructions, when executed by the at least one processing unit, cause the computing device to perform a method according to the first aspect.

In a fourth aspect of the present disclosure, a computer-readable storage medium is provided. The computer-readable storage medium having a computer program stored thereon, wherein the computer program is executable by a processor to implement a method according to the first aspect.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1A illustrates a schematic diagram of an example environment in which embodiments of the present disclosure can be implemented;

FIG. 1B is an example schematic diagram of a shortcut instruction in an interaction window of session mode according to some embodiments of the present disclosure;

FIG. 1C is an example schematic diagram of a shortcut instruction in an interaction window of floating window mode according to some embodiments of the present disclosure;

FIG. 2 illustrates a schematic diagram of an example configuration page for a shortcut instruction according to some embodiments of the present disclosure;

FIG. 3 illustrates an example configuration of output parameters of a shortcut instruction according to some embodiments of the present disclosure;

FIG. 4A illustrates a schematic diagram of an example session window including shortcut instructions according to some embodiments of the present disclosure;

FIG. 4B illustrates a schematic diagram of an example session window presenting an execution result of a shortcut instruction according to some embodiments of the present disclosure;

FIG. 5 shows a flowchart of a process for information interaction according to some embodiments of the present disclosure;

FIG. 6 illustrates a block diagram of an apparatus for information interaction according to some embodiments of the present disclosure; and

FIG. 7 illustrates a block diagram of a device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below.

As used herein, the term “model” may learn an association relationship between respective inputs and outputs from training data such that a corresponding output may be generated for a given input after training is completed. The model may be generated based on machine learning techniques. As used herein, a “model” may also be referred to as a “machine learning model,” a “learning model,” a “machine learning network,” or a “learning network,” which may be used interchangeably herein. A model may comprise different types of processing units or networks.

As used herein, unless explicitly stated otherwise, performing a step “in response to A” does not mean that the step is performed immediately after “A”, but may include one or more intermediate steps.

It is to be understood that the data involved in this technical solution (including but not limited to the data itself, data acquisition, use, storage or deletion) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained, wherein the user may include any type of rights holder, such as an individual, an enterprise, and a group.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

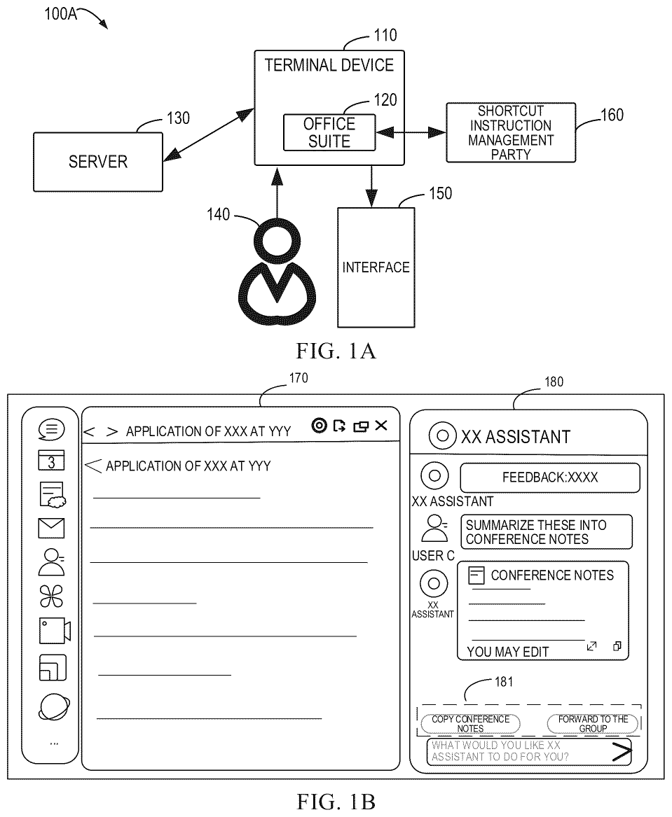

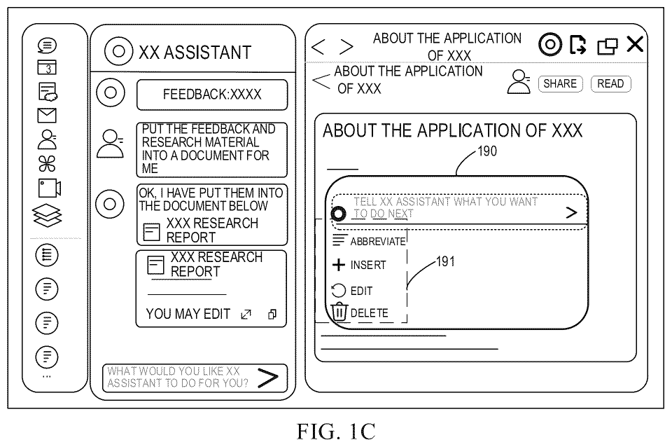

FIG. 1A illustrates a schematic diagram of an example environment 100 in which embodiments of the present disclosure can be implemented. In this example environment 100, an office suite 120 is installed in the terminal device 110. A user 140 may interact with the office suite 120 via the terminal device 110 and/or an attachment device of the terminal device 110. The office suite 120 can provide integration of multiple components to the user 140. These components may serve as component modules in the office suite 120. Components integrated in the office suite 120 are sometimes referred to as “office applications”, “office components”, “collaborative office platforms”, and the like. As an example, components integrated in the office suite 120 may include, but are not limited to, one or more of: a chat component (also referred to as an instant messaging (IM) component), a document component, an audio-video conferencing component, a mail component, a calendar component, a schedule component, a task component, a target, and an objective and key result (OKR) component.

In some embodiments, the office suite 120 may be downloaded as an application, installed on the terminal device 110. In some embodiments, the office suite 120 may also be accessed in other manners, such as web page access.

In the environment 100 of FIG. 1A, if the office suite 120 is started, the terminal device 110 may present an interface 150 of the office suite 120 to the user 140. The interface 150 is also sometimes referred to as a client interface. The interface 150 may include various interfaces which can be provided by the office suite 120, such as a session interface presenting chat contents, a video conference interface, a file sharing interface, and the like.

In some embodiments, terminal device 110 communicates with server 130 to enable provision of services to office suite 120.

The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structure and function of each element in the environment 100 are described for illustrative purposes only, and are not intended to imply any limitation on the scope of the present disclosure. For example, the embodiments of the present disclosure may be applied to any suitable one or more applications, not limited to office suites.

In some embodiments of the present disclosure, a digital assistant is configured for the user 140. The digital assistant may be implemented in any suitable form. In some embodiments, the digital assistant of the user 140 may be used as a contact of user 140 for interaction. Such a digital assistant may uniquely correspond to the user 140. In other words, the digital assistant of the user 140 may be specific to or exclusively belong to the user 140. For example, during the process in which the digital assistant provides assistance or service to the user 140, the digital assistant may utilize information related to its historical interaction with the user 140, data authorized by the user 140 which it can access, contents of its current conversation with the user, and the like. If the user 140 is an entity or an individual, such a digital assistant may be considered a personal digital assistant. It may be understood that the digital assistant in the embodiments of the present disclosure is based on the authorization of the user 140 to access the data to be granted. Of course, in some other embodiments of the present disclosure, the digital assistant may not be specific to or exclusively belong to a certain user, which is only an example and is not limited herein.

It should be understood that the “uniquely correspond to” or the like in this disclosure is not intended to limit that the digital assistant will be updated accordingly based on the interaction process between the user 140 and the digital assistant.

In some embodiments, the digital assistant may be implemented in a single component or application, such as an IM component. In some embodiments, the digital assistant may be implemented in multiple components. For example, these components may be different components of an office suite or a collaborative office platform. In some embodiments, the digital assistant may be implemented directly in the terminal device 110 without being attached to any application. In such an embodiment, the digital assistant provides assistance to the user 140 in the form of a contact.

In some embodiments of the present disclosure, the digital assistant may be an application or device implemented based on machine learning techniques. The user may send an instruction to the digital assistant through voice, image, natural language text, etc., and the digital assistant may understand the voice, image or natural language input by the user based on the machine learning model, and make a respond. Prompts are inputs or templates of inputs to the model, which can be natural language and/or other modal data for guiding or motivating the model to complete a particular process to obtain a desired model output.

When the user interacts with the digital assistant, the user may use shortcut instructions provided by the system in addition to inputting instructions (voice, image, natural language text, etc.).

In some embodiments, the shortcut instruction may be provided to the user in the form of a control (shortcut instruction button) after the debugged Prompt is packaged. The shortcut instruction supports one-key triggering of the user to input the packaged Prompt to the model to obtain a corresponding output result. The shortcut instruction enables the user to obtain relatively stable execution results at low cost.

In some embodiments, the shortcut instruction may include three types: a shortcut instruction without a parameter, a shortcut instruction with a parameter, a generation or query shortcut instruction (also referred to as an inquiry-type instruction).

In some embodiments, after a shortcut instruction without a parameter is selected, the digital assistant may directly execute an operation corresponding to the shortcut instruction. For example, the shortcut instruction without a parameter may be booking a conference and summarizing a conference. After a shortcut instruction with a parameter is selected, an input box or a secondary menu may be further presented, and after the user fills the parameter in the input box, the digital assistant may execute an operation corresponding to the shortcut instruction. For example, the shortcut instruction with parameters is “summary”, and after the user selects the shortcut instruction, the user is further prompted to input an object to be summarized, for example, to present a secondary menu that “writes a summary about XXX”, and the user may input an object to be summarized, for example, select a document. The inquiry-type shortcut instruction may be generated by a predetermined model, for example, the user may generate some inquiry-type shortcut instructions, such as “whether to share this document” in the mode of reading the document.

As an example, the execution mode of the shortcut instruction includes generating a prompt for a predetermined model, for example, generating the prompt by using a prompt template for the predetermined model. The execution mode may further be invoking an application programming interface (API) of the predetermined model, for example, some shortcut instruction(s) are bound to an API of a corresponding predetermined model, and when some shortcut instruction(s) are executed, the API may be invoked to enable the predetermined model to perform a corresponding operation.

After the digital assistant is woken up in the application, an interaction window of session mode or an interaction window of floating window mode may be presented. As an example, FIG. 1B and FIG. 1C each show a schematic diagram of shortcut instructions presented in two modes of interaction windows.

As an example, referring to FIG. 1B, an interface currently presented by the terminal device is an interface 170 of a document application. The digital assistant is woken up in this interface 170 and presents an interaction window 180 of session mode. In the interaction window 180 of session mode, shortcut instructions 181 are presented, such as a shortcut instruction “copy conference notes” and a shortcut instruction “forward to the group”. The interaction window of session mode may also be referred to as a session window.

As an example, referring to FIG. 1C, an interface currently presented by the terminal device is an interface of a document application, the digital assistant is woken up in the document application, and an interaction window 190 of floating window mode is presented. In the interaction window 190 of floating window mode, shortcut instructions 191 are presented, such as a shortcut instruction “abbreviate”, a shortcut instruction “insert”, a shortcut instruction “edit”, a shortcut instruction “delete”, and the like.

In an embodiment of the present disclosure, the environment 100 may further provide a shortcut instruction management platform 160, which can manage the shortcut instruction presented in the digital assistant. The management, for example, includes how to create shortcut instructions for different applications, which shortcut instructions to be presented in different application scenarios, when to present shortcut instructions and how to execute shortcut instructions. Although the shortcut instruction management platform 160 is shown separately, it should be understood that this is merely an example. In some embodiments, the shortcut instruction management platform 160 may be integrated into the office suite 120 or implemented as an independent platform or device. In some embodiments, the shortcut instruction management platform 160 may be at least partially integrated in the server 130.

Conventionally, the execution result of the shortcut instruction is presented to the user in a single style. For example, the execution results are typically presented in text. However, the execution result of some shortcut instructions may not be suitable to be presented in text, or is not intuitive enough to be presented in text.

To this end, the embodiments of the present disclosure provide an improved solution for information interaction, which allows a user or other related party of a shortcut instruction to define a reply type of a digital assistant to the shortcut instruction. In this solution, configuration information for the a shortcut instruction is received, which indicates a reply type of a first digital assistant to the first shortcut instruction. Based on the configuration information, an execution result of executing the first shortcut instruction by the first digital assistant is provided to a first user. A type of at least part of the execution result is consistent with the reply type indicated by the configuration information. In this way, the execution result of the shortcut instruction can be flexibly improved. Such flexible provision may be adapted to different types of execution results and/or user needs of the shortcut instruction. This advantageously improves the assistance efficiency of the digital assistant to the user as well as the user experience.

For a clearer description of the embodiments of the present disclosure, some example embodiments of the present disclosure will be described below with continued reference to the accompanying drawings. In the following, mainly the office suite is described as an example scenario, but this is merely illustrative and is not intended to limit the scope of the present disclosure. The digital assistant may be implemented in any other application or scenario, not limited to an office suite.

In the embodiments of the present disclosure, the shortcut instruction management platform 160 may support definition of the reply type of the shortcut instruction. For example, the shortcut instruction management platform 160 may receive configuration information for one or more shortcut instructions (also referred to as a first shortcut instruction for ease of description). The configuration information indicates a reply type of a first digital assistant to the first shortcut instruction. In some embodiments, the configuration information may also indicate other information, as will be described below.

The reply type may include any suitable type of information presentation mode. For example, the reply type may be a message card, which is a type of multimedia messages. For another example, the reply type may be an offline file of predetermined type, including but not limited to a PDF file, a WORD file, an EXCEL file, an audio file, an image file, a video file, and the like. For another example, the reply type may be an online file of predetermined type, such as an online document, an online table, a webpage link, or the like. The reply type may further be a text message. The reply type may be a combination of two or more of the types described above.

In some embodiments, the configuration information may be received from a first application associated with the first shortcut instruction. For example, the first application may be an application which registers the first shortcut instruction to the shortcut instruction management platform 160, or may be an application which needs to use the first shortcut instruction.

For example, the shortcut instruction management platform 160 may provide a configuration page for configuring a shortcut instruction to an associated party (for example, a creator or an operator of the first application) of the first application. The associated party of the first application may input the configuration information for the first shortcut instruction in the configuration page.

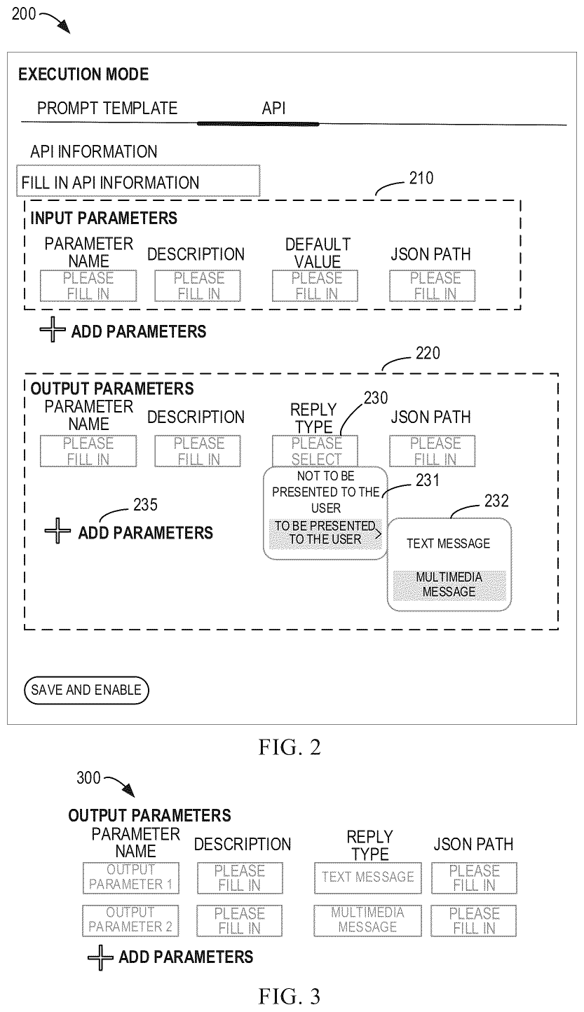

One example is described with reference to FIG. 2. FIG. 2 illustrates an example configuration page 200. The configuration page 200 includes a configuration region 210 for input parameters and a configuration region 220 for output parameters. As mentioned above, for a shortcut instruction with parameters, a user input parameter value of the shortcut instruction needs to be clicked. The output parameter may be used to define a presentation parameter of an execution result of the shortcut instruction. A control 230 for configuring a reply type is provided in the configuration area 220. If the control 230 is triggered, a drop-down menu 231 may be presented. Through the drop-down menu 231, the associated party of the application may select whether to present the execution result to the user. Where the execution result is to be presented to the user, a drop-down menu 232 may be further presented. Through the drop-down menu 232, the associated party may select a reply type which shows the execution result to the user, such as a “text message” and a “multimedia message” shown in FIG. 2 as examples.

In some embodiments, the reply of the first digital assistant to the first shortcut instruction may include a plurality of messages, and the configuration information indicates a respective reply type of at least part of the plurality of messages. For example, the plurality of messages may correspond to a plurality of output parameters of the shortcut instruction. In the configuration page 200 shown in FIG. 2, the associated party may add the output parameter by triggering a control 235, i.e., may set the number and related configuration of reply messages.

One example is described with reference to FIG. 3. FIG. 3 illustrates a configuration area 300 for output parameters of a shortcut instruction. As shown in FIG. 3, the shortcut instruction is configured with two output parameters, wherein a reply type for an output parameter 1 is a text message, and a reply type for an output parameter 2 is a multimedia message. That is, a first reply message of the digital assistant to the shortcut instruction is displayed in text form, and a second reply message of the digital assistant to the shortcut instruction is displayed in multimedia form.

The configuration information described above may be provided by an associated party of the first application, or may be provided by an associated party (for example, a creator or an operator) of the first digital assistant.

In some embodiments, the user 140 may provide the configuration information, that is, the user may customize the reply mode of the shortcut instruction. For example, a first user may configure a reply type for one or more shortcut instructions in a personal homepage of the first digital assistant.

In some embodiments, the shortcut instruction management platform 160 may provide a settings control for the reply type of the shortcut instruction to the user 140. For example, the first shortcut instruction may be presented in an interaction interface between the first user and the first digital assistant. The interaction interface here may be an interaction window of floating window mode or an interaction window of session mode. If the first shortcut instruction is triggered, the settings control for the reply type of the first shortcut instruction may be presented. The first user may provide the configuration information via the settings control, e.g., selecting a reply type to be used from various types such as a text message, a message card, a predetermined type of file, and a multimedia file. The settings control may be in any suitable form. The embodiments of the present disclosure are not limited in this respect.

In some embodiments, the first shortcut instruction may be a shortcut instruction with parameters. Correspondingly, the reply type is received as a user input parameter of the first shortcut instruction. For example, after the first shortcut instruction is triggered, an input box or a secondary menu may be further presented. The input box or the secondary menu includes an option for the reply type. After the user fills the reply type in the input box or selects the reply type through the secondary menu, the shortcut instruction management platform 160 may receive the reply type indicated by the user as at least part of the configuration information.

After obtaining the configuration information for the first shortcut instruction, the shortcut instruction management platform 160 may provide, to the first user based on the configuration information, an execution result of executing the first shortcut instruction by the first digital assistant. A type of at least part of the execution result is consistent with the reply type indicated by the configuration information.

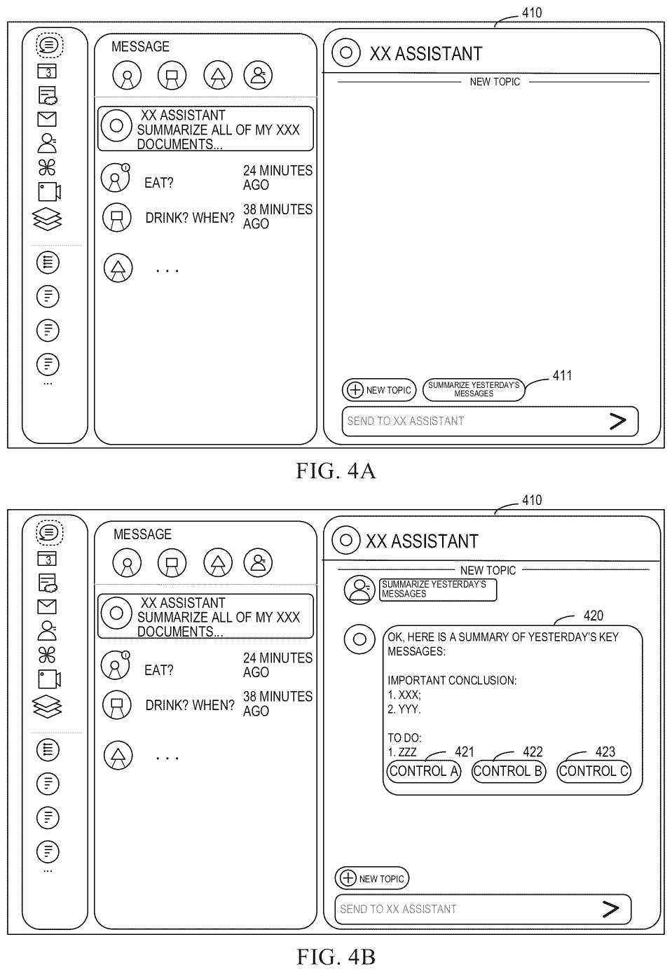

An example is described below in conjunction with FIGS. 4A and 4B with the reply type as a message card. FIG. 4A illustrates a session window 410 between a user and a digital assistant. A shortcut instruction 411 that “summarizes yesterday's messages” is shown in a session window 410. The reply type configured for the shortcut instruction 411 is a message card. The user triggers the shortcut instruction 411. Correspondingly, the digital assistant executes the shortcut instruction 411. As shown in FIG. 4B, the digital assistant presents an execution result in a message card 420 in the session window 410.

In some embodiments, as mentioned above, the reply of the first digital assistant to the first shortcut instruction may include a plurality of messages, and the configuration information indicates a respective reply type of at least part of the plurality of messages. In such an embodiment, at least part of the execution result may be presented in the at least part of the plurality of messages based on the corresponding reply type of the part of the messages in the session interface. For example, for the example shown in FIG. 3, in a session interface between the user and the digital assistant, a part corresponding to the output parameter 1 is presented in a text message, and a part corresponding to the output parameter 2 is presented in a multimedia message (for example, a message card).

In some embodiments, if the at least part of the execution result is presented in a message card, one or more controls may be provided in the message card for performing operations related to the execution result. For example, as shown in FIG. 4B, a control A 421, a control B 422, and a control C 423 are provided in the message card 420. These controls may be used to trigger any suitable operations related to execution results, such as subscribing to execution results, regenerating execution results, supplementing missing information, or confirming execution results, etc.

In some embodiments, if the reply type is a predetermined type, the presented execution result may be updated. The predetermined type may be, for example, a message card, a multimedia file, or the like. As an example, if a data source or condition for obtaining the execution result is updated, the presented execution result may be updated accordingly. In this way, the user can know the effect caused by the relevant changes.

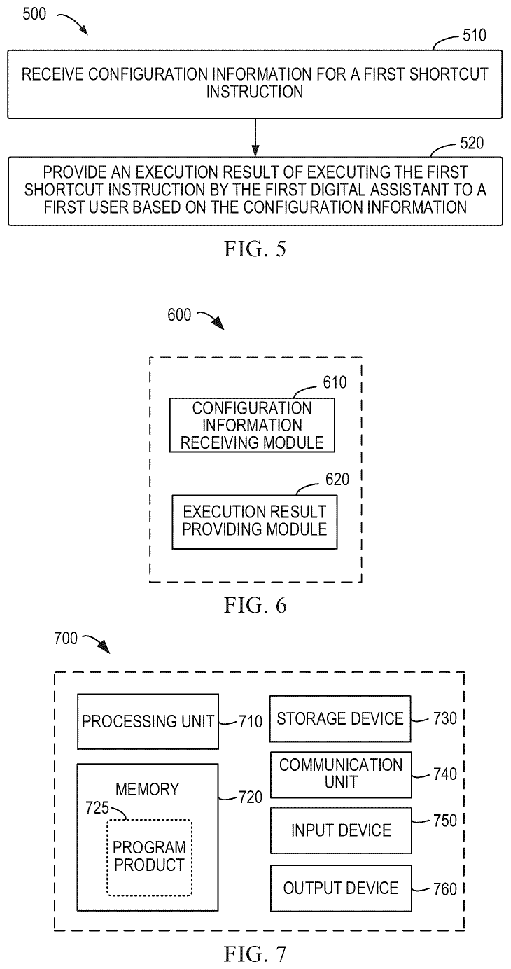

FIG. 5 shows a flowchart of a process 500 of information interaction according to some embodiments of the present disclosure. The process 500 may be implemented at the shortcut instruction management platform 160, or the server 130, or the terminal device 110, or a combination thereof. The process 500 is illustratively described below with reference to the shortcut instruction management platform 160.

At block 510, the shortcut instruction management platform 160 receives configuration information for a first shortcut instruction. The configuration information indicates a reply type of a first digital assistant to the first shortcut instruction.

At block 520, the shortcut instruction management platform 160 provides an execution result of executing the first shortcut instruction by the first digital assistant to a first user based on the configuration information. A type of at least part of the execution result is consistent with the reply type indicated by the configuration information.

In some embodiments, receiving the configuration information for the first shortcut instruction comprises: receiving the configuration information from a first application associated with the first shortcut instruction.

In some embodiments, receiving the configuration information for the first shortcut instruction comprises: presenting the first shortcut instruction in an interaction interface between the first user and the first digital assistant; presenting a settings control for the reply type in response to the first shortcut instruction being triggered; and receiving the configuration information via the settings control.

In some embodiments, the first shortcut instruction is a shortcut instruction with parameters, and the reply type is received as a user input parameter of the first shortcut instruction.

In some embodiments, the reply of the first digital assistant to the first shortcut instruction comprises a plurality of messages, and the configuration information indicates a corresponding reply type of at least part of the plurality of messages, and providing the execution result of the first shortcut instruction to the first user comprises: presenting, in a session interface between the first user and the first digital assistant, at least part of the execution result in at least part of the plurality of messages based on a corresponding reply type of the at least part of the plurality of messages.

In some embodiments, the reply type comprises at least one of: a message card; an offline file with predetermined type; and an online file with predetermined type.

In some embodiments, providing the execution result comprises: presenting a message card comprising at least part of the execution result in a session window between the first user and the first digital assistant, and providing one or more controls in the message card for performing operations related to the execution result.

In some embodiments, the reply type is a predetermined type, and the process 500 further comprises: updating the execution result in response to a condition related to the first shortcut instruction being satisfied.

In some embodiments, the condition related to the first shortcut instruction being satisfied comprises: a data source or condition for obtaining the execution result of the first shortcut instruction being updated.

FIG. 6 shows a flowchart of an apparatus 600 for information interaction according to some embodiments of the present disclosure. The apparatus 600 may be implemented or included at the shortcut instruction management platform 160, or the server 130, or the terminal device 110, or a combination thereof. The various modules/components in the apparatus 600 may be implemented by hardware, software, firmware, or any combination thereof.

As shown, the apparatus 600 comprises a configuration information receiving module 610 configured to receive configuration information for a first shortcut instruction, wherein the configuration information indicates a reply type of a first digital assistant to the first shortcut instruction. The apparatus 600 further comprises an execution result providing module 620 configured to provide an execution result of executing the first shortcut instruction by the first digital assistant to a first user based on the configuration information, wherein a type of at least part of the execution result is consistent with the reply type indicated by the configuration information.

In some embodiments, the configuration information receiving module 610 is further configured to: receive the configuration information from a first application associated with the first shortcut instruction.

In some embodiments, the configuration information receiving module 610 is further configured to: present the first shortcut instruction in an interaction interface between the first user and the first digital assistant; present a settings control for the reply type in response to the first shortcut instruction being triggered; and receive the configuration information via the settings control.

In some embodiments, the first shortcut instruction is a shortcut instruction with parameters, and the reply type is received as a user input parameter of the first shortcut instruction.

In some embodiments, the reply of the first digital assistant to the first shortcut instruction comprises a plurality of messages, and the configuration information indicates a corresponding reply type of at least part of the plurality of messages, and the execution result providing module 620 is further configured to: present, in a session interface between the first user and the first digital assistant, at least part of the execution result in at least part of the plurality of messages based on a corresponding reply type of the at least part of the plurality of messages.

In some embodiments, the reply type comprises at least one of: a message card; an offline file with predetermined type; and an online file with predetermined type.

In some embodiments, the execution result providing module 620 is further configured to: present a message card comprising at least part of the execution result in a session window between the first user and the first digital assistant, and provide one or more controls in the message card for performing operations related to the execution result.

In some embodiments, the reply type is a predetermined type, and the apparatus 600 further comprises a result updating module configured to update the execution result in response to a condition related to the first shortcut instruction being satisfied.

In some embodiments, the condition related to the first shortcut instruction being satisfied comprises: a data source or condition for obtaining the execution result of the first shortcut instruction being updated.

FIG. 7 illustrates a block diagram of an electronic device 1000 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the terminal device 110, the shortcut instruction management platform 160 or the server 130 in FIG. 1.

As shown in FIG. 7, the electronic device 700 is in the form of a general purpose computing device. Components of the electronic device 700 may include, but are not limited to, one or more processors or processing units 710, a memory 720, a storage device 730, one or more communication units 740, one or more input devices 750, and one or more output devices 760. The processing unit 710 may be a physical or virtual processor and may execute various processing based on the programs stored in the memory 720. In a multi-processor system, a plurality of processing units executes computer-executable instructions in parallel to enhance parallel processing capability of the electronic device 700.

The electronic device 700 usually includes a plurality of computer storage mediums. Such mediums may be any attainable medium accessible by the electronic device 700, including but not limited to, a volatile and non-volatile medium, a removable and non-removable medium. The memory 720 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 730 may be a removable or non-removable medium, and may include a machine-readable medium (e.g., a memory, a flash drive, a magnetic disk) or any other medium, which may be used for storing information and/or data (e.g., training data for training) and be accessed within the computing device 700.

The electronic device 700 may further include additional removable/non-removable, volatile/non-volatile storage mediums. Although not shown in FIG. 7, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 720 may include a computer program product 725 having one or more program modules, and these program modules are configured for performing various methods or acts of various implementations of the present disclosure.

The communication unit 740 implements communication with another computing device via a communication medium. Additionally, functions of components of the electronic device 700 may be realized by a single computing cluster or a plurality of computing machines, and these computing machines may communicate through communication connections. Therefore, the electronic device 700 may operate in a networked environment using a logic connection to one or more other servers, a Personal Computer (PC) or a further general network node.

The input device 750 may be one or more various input devices, such as a mouse, a keyboard, a trackball, a voice-input device, and the like. The output device 760 may be one or more output devices, e.g., a display, a loudspeaker, a printer, and so on. The electronic device 700 may also communicate through the communication unit 740 with one or more external devices (not shown) as required, where the external device, e.g., a storage device, a display device, and so on, communicates with one or more devices that enable users to interact with the electronic device 700, or with any device (such as a network card, a modem, and the like) that enable the electronic device 700 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

I/we claim:

1. A method of information interaction, comprising:
receiving configuration information for a first shortcut instruction, the configuration information indicating a reply type of a first digital assistant to the first shortcut instruction; and
providing an execution result of executing the first shortcut instruction by the first digital assistant to a first user based on the configuration information, a type of at least part of the execution result being consistent with the reply type indicated by the configuration information.

2. The method of claim 1, wherein receiving the configuration information for the first shortcut instruction comprises:
receiving the configuration information from a first application associated with the first shortcut instruction.

3. The method of claim 1, wherein receiving the configuration information for the first shortcut instruction comprises:
presenting the first shortcut instruction in an interaction interface between the first user and the first digital assistant;
presenting a settings control for the reply type in response to the first shortcut instruction being triggered; and
receiving the configuration information via the settings control.

4. The method of claim 3, wherein the first shortcut instruction is a shortcut instruction with a parameter, and the reply type is received as a user input parameter of the first shortcut instruction.

5. The method of claim 1, wherein a reply of the first digital assistant to the first shortcut instruction comprises a plurality of messages, and the configuration information indicates a corresponding reply type of at least part of the plurality of messages, and providing the execution result of the first shortcut instruction to the first user comprises:
presenting, in a session interface between the first user and the first digital assistant, at least part of the execution result in at least part of the plurality of messages based on a corresponding reply type of the at least part of the plurality of messages.

6. The method of claim 1, wherein the reply type comprises at least one of:
a message card;
an offline file of a predetermined type; and
an online file of a predetermined type.

7. The method of claim 1, wherein providing the execution result comprises:
presenting a message card comprising at least part of the execution result in a session window between the first user and the first digital assistant, and
wherein one or more controls are provided in the message card for performing an operation related to the execution result.

8. The method of claim 1, wherein the reply type is a predetermined type, and the method further comprises:
updating the execution result in response to a condition related to the first shortcut instruction being satisfied.

9. The method of claim 8, wherein the condition related to the first shortcut instruction being satisfied comprises:
a data source or condition for obtaining the execution result of the first shortcut instruction being updated.

10. A computing device, comprising:
at least one processing unit; and
at least one memory coupled to the at least one processing unit and storing instructions executable by the at least one processing unit, the instructions, when executed by the at least one processing unit, causing the computing device to perform acts comprising:
receiving configuration information for a first shortcut instruction, the configuration information indicating a reply type of a first digital assistant to the first shortcut instruction; and
providing an execution result of executing the first shortcut instruction by the first digital assistant to a first user based on the configuration information, a type of at least part of the execution results being consistent with the reply type indicated by the configuration information.

11. The computing device of claim 10, wherein receiving the configuration information for the first shortcut instruction comprises:
receiving the configuration information from a first application associated with the first shortcut instruction.

12. The computing device of claim 10, wherein receiving the configuration information for the first shortcut instruction comprises:
presenting the first shortcut instruction in an interaction interface between the first user and the first digital assistant;
presenting a settings control for the reply type in response to the first shortcut instruction being triggered; and
receiving the configuration information via the settings control.

13. The computing device of claim 12, wherein the first shortcut instruction is a shortcut instruction with parameters, and the reply type is received as a user input parameter of the first shortcut instruction.

14. The computing device of claim 10, wherein the reply of the first digital assistant to the first shortcut instruction comprises a plurality of messages, and the configuration information indicates a corresponding reply type of at least part of the plurality of messages, and providing the execution result of the first shortcut instruction to the first user comprises:
presenting, in a session interface between the first user and the first digital assistant, at least part of the execution result in at least part of the plurality of messages based on a corresponding reply type of the at least part of the plurality of messages.

15. The computing device of claim 10, wherein the reply type comprises at least one of:
a message card;
an offline file with predetermined type; and
an online file with predetermined type.

16. The computing device of claim 10, wherein providing the execution result comprises:
presenting a message card comprising at least part of the execution result in a session window between the first user and the first digital assistant, and
providing one or more controls in the message card for performing operations related to the execution result.

17. The computing device of claim 1, wherein the reply type is a predetermined type, and the acts further comprise:
updating the execution result in response to a condition related to the first shortcut instruction being satisfied.

18. The computing device of claim 17, wherein the condition related to the first shortcut instruction being satisfied comprises:
a data source or condition for obtaining the execution result of the first shortcut instruction being updated.

19. A non-transitory computer-readable storage medium having a computer program stored thereon, wherein the computer program is executable by a processor to implement a method comprising:
receiving configuration information for a first shortcut instruction, the configuration information indicating a reply type of a first digital assistant to the first shortcut instruction; and
providing an execution result of executing the first shortcut instruction by the first digital assistant to a first user based on the configuration information, a type of at least part of the execution results being consistent with the reply type indicated by the configuration information.

20. The non-transitory computer-readable storage medium of claim 19, wherein receiving the configuration information for the first shortcut instruction comprises:
receiving the configuration information from a first application associated with the first shortcut instruction.
